(19) United States
(12) Patent Application Publication
(10) Pub. No.: US 2024/0369899 A1
(43) Pub. Date: Nov. 7, 2024

(54) WAVELENGTH SELECTIVE SWITCH

(71) Applicant: FUJIFILM Corporation, Tokyo (JP)

(72) Inventors: Kazuya HISANAGA, Minamiashigara-shi (JP); Yujiro YANAI, Minamiashigara-shi (JP); Yukito SAITOH, Minamiashigara-shi (JP)

(73) Assignee: FUJIFILM Corporation, Tokyo (JP)

(21) Appl. No.: 18/774,068

(22) Filed: Jul. 16, 2024

Related U.S. Application Data
(63) Continuation of application No. PCT/JP2023/001163, filed on Jan. 17, 2023.

(30) Foreign Application Priority Data
Jan. 17, 2022 (JP) 2022-005198

(51) Int. Cl. G02F 1/31

(52) U.S. Cl. CPC G02F 1/31

(57) ABSTRACT

Provided is a wavelength selective switch where loss caused by a twisted effect of liquid crystal molecules of a LCOS peripheral part is reduced and the loss is small. The wavelength selective switch includes: one or more input ports; one or more output ports; a polarization controller that adjusts a polarization state of light incident from the input ports; a dispersive element that demultiplexes wavelength-multiplexed light incident from the input ports; and a deflection element that controls deflection of the demultiplexed light, in which the deflection element is a liquid crystal on silicon (LCOS) including an optical compensation layer that is provided on an incident surface to compensate for diffraction loss of a peripheral part.

### CROSS-REFERENCE TO RELATED APPLICATIONS

This application is a Continuation of PCT International Application No. PCT/JP2023/001163 filed on Jan. 17, 2023, which claims priority under 35 U.S.C. § 119(a) to Japanese Patent Application No. 2022-005198 filed on Jan. 17, 2022. The above applications are hereby expressly incorporated by reference, in their entirety, into the present application.

### BACKGROUND OF THE INVENTION

### 1. Field of the Invention

The present invention relates to a wavelength selective switch.

### 2. Description of the Related Art

As a wavelength selective switch, a liquid crystal on silicon (LCOS) is used. The LCOS has a configuration where a liquid crystal material is interposed between a transparent glass layer including a transparent electrode and a silicon substrate that is divided into a two-dimensional array of individually addressable pixels. Each of the pixels can be driven by a voltage signal, and by presenting a phase pattern having a diffraction grating shape, a diffraction direction of incident light can be controlled, and the light can be coupled to any emission port.

The wavelength selective switch using the LCOS is advantageous in that, for example, a reflecting surface having any size can be configured by fine pixels and the wavelength selective switch can be aligned with an optical system by adjusting an image display position by software after mounting, and the wavelength selective switch is prospective as the next-generation device.

On the other hand, in the wavelength selective switch using the LCOS, in a case where a diffraction angle is large in a peripheral part of a LCOS element surface, there is a problem in that loss caused by a twisted effect of liquid crystal molecules occurs.

### SUMMARY OF THE INVENTION

JP2020-074026A discloses a wavelength selective switch including a LCOS where crosstalk caused by scattering is reduced, but does not mention the loss caused by the twisted effect of liquid crystal molecules in the LCOS peripheral part.

Accordingly, an object of the present invention is to provide a wavelength selective switch where loss caused by a twisted effect of liquid crystal molecules of a LCOS peripheral part is reduced and the loss is small.

As a result of a thorough investigation, the present inventors found that a wavelength selective switch where loss caused by a twisted effect of liquid crystal molecules of a LCOS peripheral part is reduced and the loss is small can be provided with the following configuration. In this configuration, the wavelength selective switch includes: one or more input ports; one or more output ports; a polarization controller that adjusts a polarization state of light incident from the input ports; a dispersive element that demultiplexes wavelength-multiplexed light incident from the input ports; and a deflection element that controls deflection of the demultiplexed light, in which the deflection element is configured by a liquid crystal on silicon (LCOS), and an optical compensation layer is disposed in a peripheral part of the liquid crystal on silicon.

That is, the present inventors found that the object can be achieved with the following configurations.

[1] A wavelength selective switch comprising:
one or more input ports;
one or more output ports;
a polarization controller that adjusts a polarization state of light incident from the input ports;
a dispersive element that demultiplexes wavelength-multiplexed light incident from the input ports; and
a deflection element that controls deflection of the demultiplexed light,
in which the deflection element is configured by a liquid crystal on silicon (LCOS), and
an optical compensation layer is disposed in a peripheral part of the liquid crystal on silicon.

[2] The wavelength selective switch according to [1],
in which the optical compensation layer is a λ/2 plate.

[3] The wavelength selective switch according to [1],
in which the optical compensation layer is a liquid crystal diffraction element.

According to the present invention, it is possible to provide a wavelength selective switch where loss caused by a twisted effect of liquid crystal molecules of a LCOS peripheral part is reduced and the loss is small.

### BRIEF DESCRIPTION OF THE DRAWINGS

FIG. 1 is a conceptual diagram showing a configuration of a wavelength selective switch 1 according to a first embodiment of the present invention.

FIG. 2 is a conceptual diagram showing a phase profile of a LCOS in a case where light is diffracted by the LCOS.

FIG. 3 is a conceptual diagram showing a major axis direction of a liquid crystal molecule of the LCOS.

FIG. 4 is a conceptual diagram showing a configuration of a wavelength selective switch 2 according to a second embodiment of the present invention.

FIG. 5 is a conceptual diagram showing a first example of a liquid crystal diffraction element according to the second embodiment of the present invention.

FIG. 6 is a graph showing a diffraction efficiency of the first example of the liquid crystal diffraction element according to the second embodiment of the present invention.

FIG. 7 is a conceptual diagram showing diffraction of the first example of the liquid crystal diffraction element according to the second embodiment of the present invention.

FIG. 8 is a conceptual diagram showing a second example of the liquid crystal diffraction element according to the second embodiment of the present invention.

FIG. 9 is a conceptual diagram showing transmission of incidence light in the second example of the liquid crystal diffraction element according to the second embodiment of the present invention.

FIG. 10 is a conceptual diagram showing diffraction of the second example of the liquid crystal diffraction element according to the second embodiment of the present invention.

### DESCRIPTION OF THE PREFERRED EMBODIMENTS

Hereinafter, embodiments of the present invention will be described in detail with reference to the drawings. Note that the present invention can be implemented in various different embodiments and does not limit the following embodiments.

The drawings described below are exemplary drawings for describing the present invention, and the present invention is not limited to the drawings described below.

Unless specified otherwise, the meaning of “any angle” and “parallel” includes an error range that is generally allowable in the technical field.

### First Embodiment

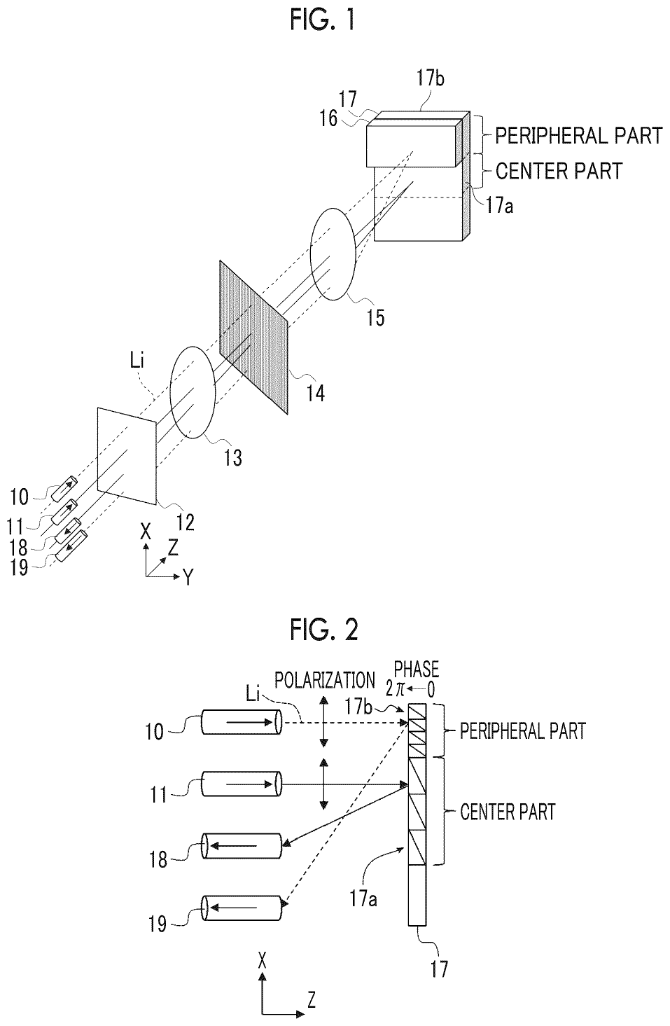

FIG. 1 is a conceptual diagram showing a configuration of a wavelength selective switch 1 according to a first embodiment of the present invention. The wavelength selective switch 1 comprises: one or more input ports 10 and 11; one or more output ports 18 and 19; a polarization controller 12 that adjusts a polarization state of light incident from the input ports 10 and 11; a lens 13 that converts polarization-adjusted light into parallel light; a dispersive element 14 that demultiplexes wavelength-multiplexed light (incidence light Li) incident from the input ports 10 and 11; a lens 15 that converts light demultiplexed and spreading in a wavelength dispersion direction into parallel light; and a deflection element (not shown) that controls deflection of the demultiplexed light. The deflection element is configured by a liquid crystal on silicon (LCOS) 17. An optical compensation layer 16 is disposed on a peripheral part 17b of the LCOS 17.

### [Input Port]

Light (for example, signal light in wavelength multiplexing optical communication) including a plurality of wavelength components is input to the input ports 10 and 11 from the outside of the wavelength selective switch 1. In FIG. 1, the number of the input ports 10 and 11 is two to simplify the description. However, the number of the input ports 10 and 11 may increase or decrease as necessary.

### [Polarization Controller]

The polarization controller 12 is provided to adjust the polarization state of the incidence light Li to a polarization direction in which the phase of the incidence light Li is changed by the LCOS 17 such that the incidence light Li can be diffracted. As the technique for obtaining the configuration, polarization diversity is well-known. Even in the present invention, the polarization diversity is used for adjusting polarization.

In the first embodiment, the incidence light Li is converted into linearly polarized light having a polarizing axis in the X direction in FIG. 1 by the polarization controller 12.

### [Dispersive Element]

The wavelength-multiplexed incidence light Li is demultiplexed into light having each of wavelengths in the Y direction by the dispersive element 14. In FIG. 1, one representative light component in the light transmitted through the dispersive element 14 is shown to simplify the description.

As the dispersive element 14, a well-known wavelength dispersive element may be used, and examples thereof include a diffraction element and a prism.

### [LCOS]

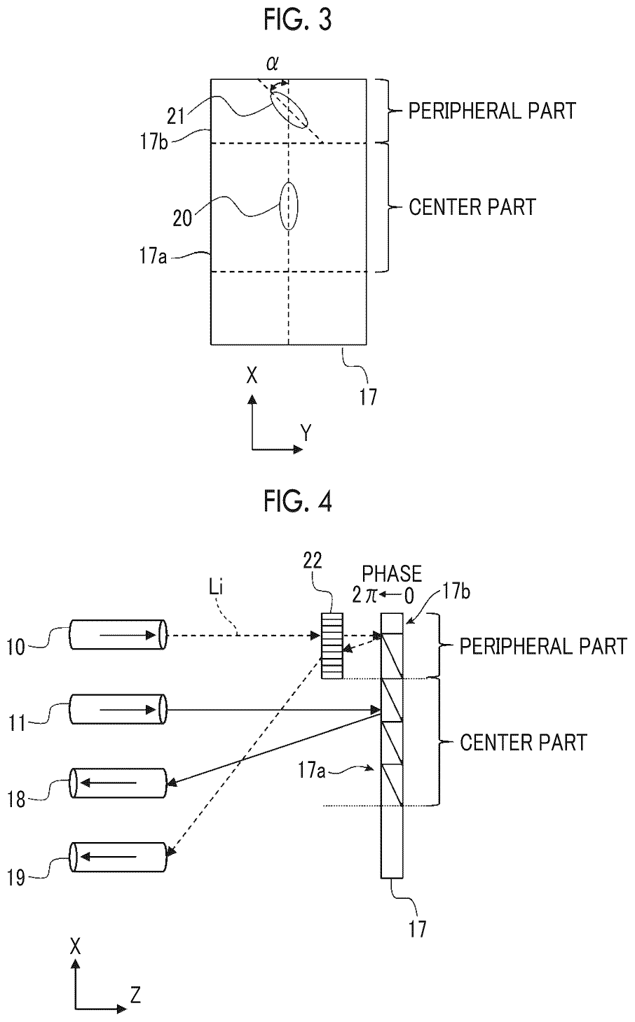

In order to couple the light demultiplexed by the dispersive element 14 to the desired output ports 18 and 19, the phase of the incidence light is modulated to be diffracted at a desired angle by the LCOS 17. In this case, in a case where the diffraction angle is large in the peripheral part 17b of the LCOS surface, loss caused by a twisted effect of liquid crystal molecules occurs, and this loss will be described using FIGS. 2 and 3.

In FIG. 2, light (incidence light Li (refer to FIG. 1) incident from the input port 10 is diffracted in the peripheral part 17b of the LCOS 17 and is coupled to the output port 19. In this case, the route of the light is indicated by a broken line. In addition, light incident from the input port 11 is diffracted in a center part 17a of the LCOS 17 and is coupled to an output port 18. In this case, the route of the light is indicated by a solid line. In a case where the broken line and the solid line indicating the routes of the light are compared to each other, it can be seen that the diffraction angle of the broken line diffracted in the peripheral part 17b of the LCOS 17 is more than that of the solid line diffracted in the center part 17a of the LCOS 17. In order to set the diffraction angle of the peripheral part 17b to be large, as in a phase profile indicated by a solid line in a cross-sectional view of the LCOS 17 in FIG. 2, a phase profile of the peripheral part 17b needs to have a fine pitch with respect to the center part 17a such that the slope is sharp. This phase profile is generated by applying a voltage to the liquid crystal molecules. Therefore, in a case where the phase profile is sharp, a phenomenon in which the liquid crystal molecules are tilted not only in the Z direction in FIG. 2 but also in the X and Y directions due to the twisted effect of the liquid crystal molecules. This phenomenon is shown in FIG. 3, in which a major axis of a liquid crystal molecule 20 of the center part 17a of the LCOS 17 faces the X direction, whereas a major axis of a liquid crystal molecule 21 of the peripheral part 17b where the phase profile is sharp is tilted by an angle α with respect to the X direction. That is, in the peripheral part 17b of the LCOS 17, the polarizing axis of the incidence light Li and the major axis of the liquid crystal molecules of the LCOS deviate from each other. As a result, diffraction loss occurs, and the efficiency of the entire wavelength selective switch decreases.

Here, the peripheral part 17b of the LCOS 17 refers to a region where the diffraction angle of the incidence light Li (refer to FIG. 1) increases in the LCOS 17. The diffraction angle is determined depending on a positional relationship between the input port and the output port. As the distance between the input port and the output port increases, the diffraction angle increases.

### [Optical Compensation Layer]

The wavelength selective switch 1 according to the first embodiment of the present invention includes an optical compensation layer 16 that compensates for the diffraction loss of the peripheral part 17b of the LCOS 17. It is preferable that the optical compensation layer 16 is a λ/2 plate that rotates a polarizing axis of linearly polarized light incident into the peripheral part 17b of the LCOS 17 to match with a slope (the angle α with respect to the X direction) of the major axis of the liquid crystal molecule 21 in FIG. 3. As a result, the polarizing axis of the linearly polarized light incident into the LCOS 17 matches with the major axis of the liquid crystal molecule 21 of the peripheral part, and the diffraction loss can be reduced.

In this case, in the center part 17a of the LCOS 17, the axis of the incident linearly polarized light does not need to be rotated. Therefore, in the center part 17a, the optical compensation layer does not need to be disposed, or a λ/2 plate having different axial angles in the peripheral part 17b and the center part 17a of the LCOS 17 may be used using pattern alignment.

The wavelength λ of the λ/2 plate refers to a wavelength of the incidence light Li (refer to FIG. 1). The wavelength λ of incidence light is a central wavelength of the incidence light. Hereinafter, unless specified otherwise, the wavelength λ of incidence light refers to a central wavelength of the incidence light.

In a case where the incidence light is light where a plurality of peak wavelengths are discretely present, the central wavelength of the incidence light is acquired using a root mean square (RMS) method. The plurality of discrete peak wavelengths are measured using an optical spectrum analyzer.

In a case where the incidence light is light where a plurality of peak wavelengths are not discretely present, a spectrum of the incidence light is measured using an optical spectrum analyzer. Among two wavelengths having a height that is ½ of a maximum peak height in the measured spectrum, in a case where a value of a shorter wavelength is represented by λ1 (nm) and a value of a longer wavelength is represented by λ2 (nm), the central wavelength and a half-width can be acquired from the following expression.

Reflection center wavelength=(λ1+λ2)/2,Half-width=(λ2−λ1)

### [Output Port]

Light having each of wavelengths is switched to the desired output ports 18 and 19 by the LCOS 17. The number of the output ports 18 and 19 may increase or decrease as necessary. In addition, the input ports 10 and 11 and the output ports 18 and 19 are suitably configured by optical waveguide members such as optical fibers.

Accordingly, with the first embodiment, it is possible to construct a wavelength selective switch where loss caused by a twisted effect of liquid crystal molecules of the peripheral part 17b of the LCOS 17 is reduced and the loss is small.

### Second Embodiment

FIG. 4 is a conceptual diagram showing a configuration of a wavelength selective switch 2 according to a second embodiment of the present invention. The second embodiment is different from the first embodiment only in that the optical compensation layer 16 is replaced with a liquid crystal diffraction element 22. Therefore, in FIG. 4, members common to those of the first embodiment are not shown.

### [Liquid Crystal Diffraction Element]

The effects of the liquid crystal diffraction element 22 in the wavelength selective switch 2 according to the second embodiment will be described using FIG. 4. As in the first embodiment, the incidence light from the input port 10 is coupled to the output port 19. The liquid crystal diffraction element 22 is disposed on the incident surface side of the LCOS 17, and a film thickness, an in-plane pitch, and a twisted angle of the liquid crystal molecules in the liquid crystal diffraction element are adjusted such that the light incident from the LCOS 17 is largely diffracted without diffracting the light incident from the input port 10. In this case, by setting the phase profile of the peripheral part 17b of the LCOS 17 is set to be the same pattern as that of the center part 17a, the diffraction angle of the incidence light is small in the LCOS 17, but the light is largely diffracted by the liquid crystal diffraction element 22 through which the light subsequently transmits, and is coupled to the output port 19. As a result, a sharp phase profile does not need to be set in the peripheral part 17b of the LCOS 17. Therefore, even in the peripheral part 17b, the diffraction loss can be suppressed to the same degree as in the center part 17a.

In this case, in the center part 17a of the LCOS 17, the light from the LCOS 17 does not need to be diffracted by the liquid crystal diffraction element 22. Therefore, in the center part 17a, the liquid crystal diffraction element does not need to be disposed, or a liquid crystal diffraction element having different alignments in the peripheral part 17b and the center part 17a may be used using pattern alignment.

The liquid crystal diffraction element 22 can be prepared, for example, using a method described in WO2020/022513A.

It is preferable that a λ/4 plate is disposed on an incident surface and an emission surface of the liquid crystal diffraction element 22. The liquid crystal diffraction element 22 efficiently diffracts circularly polarized light. Therefore, linearly polarized light emitted from the polarization controller 12 is converted into circularly polarized light by the λ/4 plate such that the diffraction efficiency can be increased. An axial angle of a slow axis of the λ/4 plate may be appropriately adjusted depending on a direction in which circularly polarized light is diffracted by the liquid crystal diffraction element 22. Light emitted from the liquid crystal diffraction element 22 is circularly polarized light, and in a case where the LCOS is used as the deflection element, linearly polarized light needs to be incident in a direction matched to a liquid crystal slow axis of the LCOS. Therefore, by disposing the λ/4 plate on the emission side, emitted circularly polarized light can be converted into linearly polarized light, and the light can be deflected by the LCOS.

Next, the liquid crystal diffraction element 22 will be described in more detail.

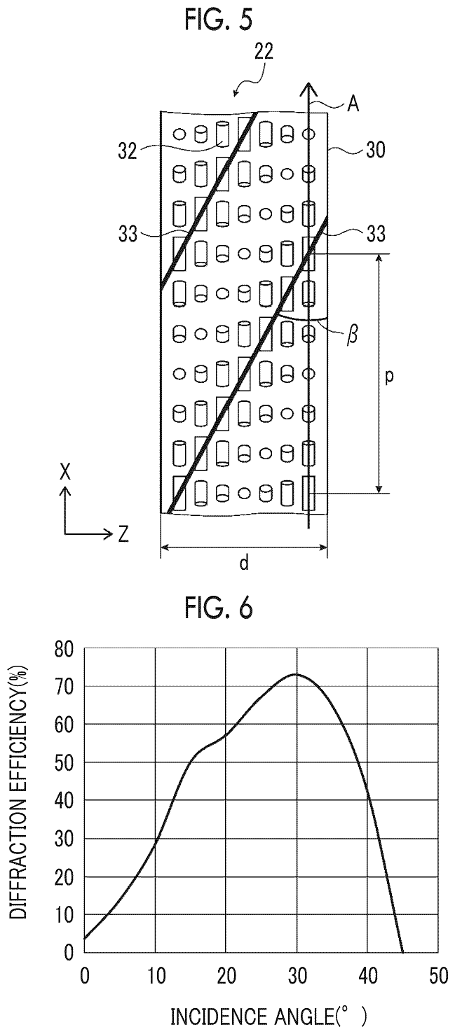

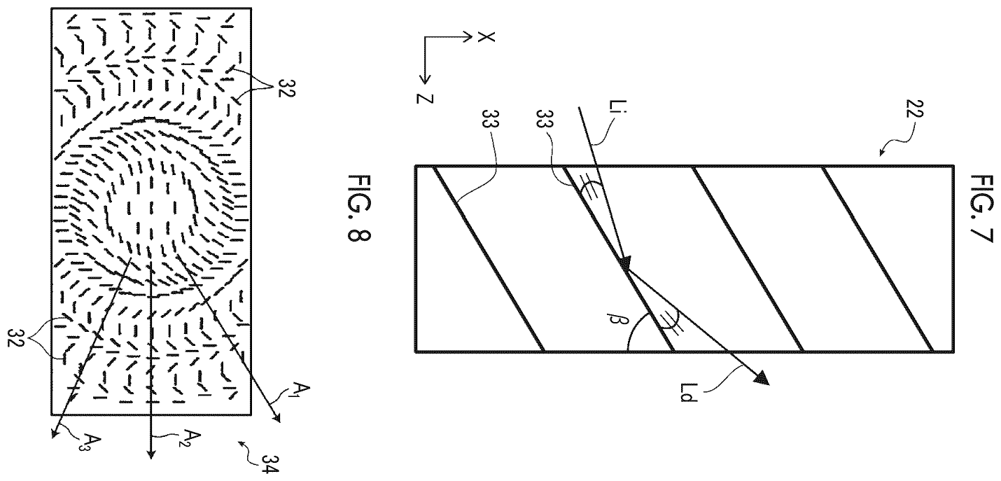

FIG. 5 is a conceptual diagram showing a first example of the liquid crystal diffraction element according to the second embodiment of the present invention. FIG. 6 is a graph showing a diffraction efficiency of the first example of the liquid crystal diffraction element according to the second embodiment of the present invention. FIG. 7 is a conceptual diagram showing diffraction of the first example of the liquid crystal diffraction element according to the second embodiment of the present invention.

For example, the liquid crystal diffraction element 22 is configured by a liquid crystal layer 30 having twisted alignment in a thickness direction as shown in FIG. 5. The liquid crystal layer 30 is a layer where a liquid crystal compound 32 is twisted and aligned in the thickness direction.

The liquid crystal layer 30 has a liquid crystal alignment pattern in which an orientation of an optical axis derived from the liquid crystal compound 32 changes while continuously rotating in at least one in-plane direction.

The liquid crystal layer 30 has twisted alignment where the liquid crystal compound 32 is helically turned and laminated, and a twisted angle in the thickness direction is less than 360°. That is, the liquid crystal compound is twisted and aligned to the degree to which it is not cholesterically aligned.

A length (distance) over which the optical axis of the liquid crystal compound 32 rotates by 180° in one direction (hereinafter, referred to as an arrow A direction) indicated by an arrow A in which the optical axis (not shown) of the liquid crystal compound 32 changes while continuously rotating in a plane is set as the length of the single period in the liquid crystal alignment pattern, that is, an in-plane pitch p.

In the liquid crystal layer 30, a tilted surface 33 is formed by the liquid crystal alignment pattern of the liquid crystal compound 32. The tilted surface 33 is formed by disposing the maximum optical axes of the liquid crystal compounds 32 in the arrow A direction.

The tilted surface 33 is observed as a dark portion by observing a cross section of the liquid crystal layer 30 with a scanning electron microscope (SEM). In addition, a tilt angle β of the tilted surface 33 can be specified by the dark portion.

The tilt angle β of the tilted surface 33 is an average value obtained by measuring an angle corresponding to the tilt angle of the dark portion at five positions.

A film thickness d of the liquid crystal layer 30 is an average value obtained by measuring five positions corresponding to the thickness of the liquid crystal layer 30.

For example, in a case where the in-plane pitch p is 5 μm, the film thickness d is 12 μm, and the tilt angle β of the tilted surface 33 is 61°, the diffraction efficiency shown in FIG. 6 is obtained. As shown in FIG. 6, incidence light incident from an oblique side at an incidence angle of 30° is most largely diffracted without diffracting incidence light incident from the front of the liquid crystal diffraction element.

By designing the tilt angle β of the tilted surface 33 such that the incidence light Li and diffracted light Ld are specularly reflected from the tilted surface 33, the diffraction efficiency at the incidence angle of the incidence light Li is the maximum.

In the liquid crystal layer 30, the in-plane pitch p is preferably 2 to 20 μm, more preferably 3 to 15 μm, and still more preferably 4 to 10 μm.

The tilt angle β is preferably 10° to 90°, more preferably 20° to 80°, and still more preferably 30° to 70°.

The film thickness d is preferably 1 to 20 μm, more preferably 2 to 19 μm, and still more preferably 3 to 18 μm.

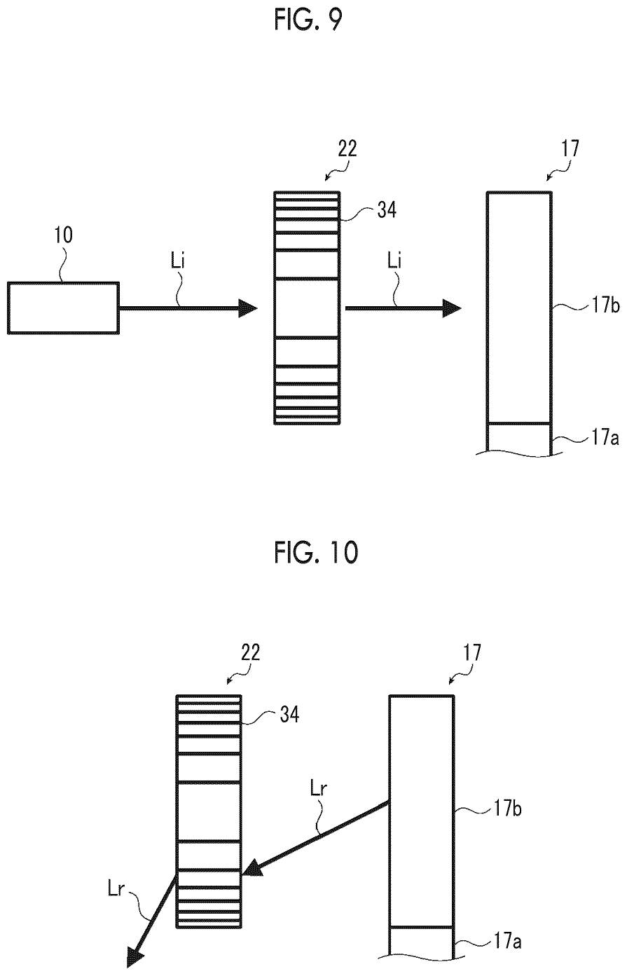

FIG. 8 is a conceptual diagram showing a second example of the liquid crystal diffraction element according to the second embodiment of the present invention. FIG. 9 is a conceptual diagram showing transmission of incidence light in the second example of the liquid crystal diffraction element according to the second embodiment of the present invention. FIG. 10 is a conceptual diagram showing diffraction of the second example of the liquid crystal diffraction element according to the second embodiment of the present invention.

For example, the liquid crystal diffraction element 22 can also be configured by an optically-anisotropic layer 34 shown in FIG. 8. The liquid crystal alignment pattern in the optically-anisotropic layer 34 shown in FIG. 8 is a concentric pattern where the one direction in which the orientation of the optical axis of the liquid crystal compound 32 changes while continuously rotating is provided in a concentric shape from the inner side toward the outer side. In other words, the liquid crystal alignment pattern of the optically-anisotropic layer 34 shown in FIG. 8 is a liquid crystal alignment pattern where the one direction in which the orientation of the optical axis of the liquid crystal compound 32 changes while continuously rotating is provided in a radial shape from the center of the optically-anisotropic layer 34.

In FIG. 8, only the liquid crystal compound 32 on the surface is shown. However, the optically-anisotropic layer 34 has a structure where the liquid crystal compound 32 is laminated on the liquid crystal compound 32 on the surface.

In the optically-anisotropic layer 34 shown in FIG. 8, the optical axis (not shown) of the liquid crystal compound 32 is a longitudinal direction of the liquid crystal compound 32.

In the optically-anisotropic layer 34, the orientation of the optical axis of the liquid crystal compound 32 changes while continuously rotating in a plurality of directions from the center toward the outer side of the optically-anisotropic layer 34, for example, a direction indicated by an arrow A₁, a direction indicated by an arrow A₂, a direction indicated by an arrow A₃, or . . . .

In the optically-anisotropic layer 34 having the concentric liquid crystal alignment pattern, that is, the liquid crystal alignment pattern in which the optical axis changes while continuously rotating in a radial shape, transmission of incidence light can be allowed as diverging light or converging light depending on the rotation direction of the optical axis of the liquid crystal compound 32 and the direction of circularly polarized light to be incident.

By setting the liquid crystal alignment pattern of the optically-anisotropic layer in a concentric shape, the optically-anisotropic layer 34 exhibits, for example, a function as a convex lens or a concave lens.

Here, in a case where the liquid crystal alignment pattern of the optically-anisotropic layer is concentric such that the optical element functions as a convex lens, it is preferable that the single period Λ over which the optical axis rotates by 180° in the liquid crystal alignment pattern gradually decreases from the center of the optically-anisotropic layer 34 toward the outer direction in the one direction in which the optical axis continuously rotates.

The refraction angle of light with respect to an incidence direction increases as the single period Λ in the liquid crystal alignment pattern decreases. Accordingly, the single period Λ in the liquid crystal alignment pattern gradually decreases from the center of the optically-anisotropic layer 34 toward the outer direction in the one direction in which the optical axis continuously rotates. As a result, the light collecting power of the optically-anisotropic layer 34 can be improved, and the performance as a convex lens can be improved.

In addition, for example, depending on the uses of the optical element such as a concave lens, it is preferable that the single period Λ over which the optical axis rotates by 180° in the liquid crystal alignment pattern gradually decreases from the center of the optically-anisotropic layer 34 toward the outer direction in the one direction by reversing the direction in which the optical axis continuously rotates.

The refraction angle of light with respect to an incidence direction increases as the single period Λ in the liquid crystal alignment pattern decreases. Accordingly, the single period Λ in the liquid crystal alignment pattern gradually decreases from the center of the optically-anisotropic layer 34 toward the outer direction in the one direction in which the optical axis continuously rotates. As a result, the light diverging power of the optically-anisotropic layer 34 can be improved, and the performance as a concave lens can be improved.

As shown in FIG. 9, in a case where the optically-anisotropic layer 34 is used as the liquid crystal diffraction element 22, the performance as a concave lens is used as described above. In this case, the incidence light Li is incident into the center of the optically-anisotropic layer 34 to suppress diffraction, and transmits through the liquid crystal diffraction element 22. Reflected light Lr from the peripheral part 17b of the LCOS 17 is incident into an end part of the optically-anisotropic layer 34 to be diffracted as shown in FIG. 10, and is emitted from the optically-anisotropic layer 34. As a result, the incidence light Li from the input port can be incident into the output port.

Even in the liquid crystal diffraction element 22 shown in FIG. 9, it is preferable that a λ/4 plate is disposed on the incident surface or the incidence side and the emission surface or the emission side of the liquid crystal diffraction element 22. Even in the liquid crystal diffraction element 22 shown in FIG. 9, as in the liquid crystal diffraction element 22 shown in FIG. 4, the liquid crystal diffraction element 22 efficiently diffracts circularly polarized light. Therefore, linearly polarized light emitted from the polarization controller 12 is converted into circularly polarized light by the λ/4 plate such that the diffraction efficiency can be increased.

The liquid crystal layer 30 can be formed by immobilizing the liquid crystal phase where the liquid crystal compound 32 is twisted and aligned in the thickness direction.

The structure in which the liquid crystal phase where the liquid crystal compound 32 is twisted and aligned in the thickness direction is immobilized may be a structure in which the alignment of the liquid crystal compound as a liquid crystal phase is immobilized. Typically, the structure is preferably a structure which is obtained by making the polymerizable liquid crystal compound to be in a state where a predetermined liquid crystal phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment form is not changed by an external field or an external force.

The structure in which a liquid crystal phase is immobilized is not particularly limited as long as the optical characteristics of the liquid crystal phase are maintained, and the liquid crystal compound 32 in the liquid crystal layer does not necessarily exhibit liquid crystallinity. For example, the molecular weight of the polymerizable liquid crystal compound may be increased by a curing reaction such that the liquid crystallinity thereof is lost.

Examples of a material used for forming the liquid crystal layer 30 include a liquid crystal composition including a liquid crystal compound. It is preferable that the liquid crystal compound is a polymerizable liquid crystal compound. In addition, the liquid crystal composition may further include other components such as a leveling agent, an alignment control agent, a polymerization initiator, a crosslinking agent, or an alignment assistant. The liquid crystal composition may include a solvent.

Examples of the liquid crystal composition for forming the liquid crystal layer 30 include a liquid crystal composition obtained by adding a chiral agent for helically aligning the liquid crystal compound 32 to the liquid crystal composition for forming the optically-anisotropic layer 34.

In a case where the liquid crystal layer 30 is formed, it is preferable that the liquid crystal layer 30 is formed by applying the liquid crystal composition to a surface where the liquid crystal layer 30 is to be formed, aligning the liquid crystal compound 32 to a state of a desired liquid crystal phase, and curing the liquid crystal compound 32.

That is, in a case where the liquid crystal layer is formed on a support, it is preferable that the liquid crystal layer 30 obtained by immobilizing the liquid crystal phase where the liquid crystal compound 32 is twisted and aligned in the thickness direction is formed by applying the liquid crystal composition to the support, aligning the liquid crystal compound 32 to a state of the liquid crystal phase where the liquid crystal compound 32 is twisted and aligned in the thickness direction, and curing the liquid crystal compound 32.

The applied liquid crystal composition is optionally dried and/or heated and then is cured to form the liquid crystal layer. In the drying and/or heating step, the liquid crystal compound 32 in the liquid crystal composition may be aligned to the liquid crystal phase where the liquid crystal compound 32 is twisted and aligned in the thickness direction. In the case of heating, the heating temperature is preferably 200° C. or lower and more preferably 130° C. or lower.

The aligned liquid crystal compound 32 is optionally further polymerized. Regarding the polymerization, thermal polymerization or photopolymerization using light irradiation may be performed, and photopolymerization is preferable. Regarding this point, the same can also be applied to the above-described optically-anisotropic layer 34.

Regarding the light irradiation, ultraviolet light is preferably used. The irradiation energy is preferably 20 mJ/cm² to 50 J/cm² and more preferably 50 to 1500 mJ/cm². In order to accelerate the photopolymerization reaction, the light irradiation may be performed under heating conditions or under a nitrogen atmosphere. The wavelength of irradiated ultraviolet light is preferably 250 to 430 nm.

Accordingly, with the second embodiment, it is possible to construct a wavelength selective switch where loss caused by a twisted effect of liquid crystal molecules of the peripheral part 17b of the LCOS 17 is reduced and the loss is small.

### EXPLANATION OF REFERENCES

10, 11: input port
12: polarization controller
13: lens
14: dispersive element
15: lens
16; optical compensation layer
17: LCOS
18, 19: output port
20: liquid crystal molecule of LCOS center part
21: liquid crystal molecule of LCOS peripheral part
22: liquid crystal diffraction element
30: liquid crystal layer
32: liquid crystal compound
33: tilted surface
34: optically-anisotropic layer
A, A₁, A₂, A₃: arrow
Ld: diffracted light
Li: incidence light
Lr: reflected light
P: helical pitch
d: film thickness
p: in-plane pitch
α: angle
β: tilt angle

What is claimed is:

1. A wavelength selective switch comprising:
one or more input ports;
one or more output ports;
a polarization controller that adjusts a polarization state of light incident from the input ports;
a dispersive element that demultiplexes wavelength-multiplexed light incident from the input ports; and
a deflection element that controls deflection of the demultiplexed light,
wherein the deflection element is configured by a liquid crystal on silicon (LCOS), and
an optical compensation layer is disposed in a peripheral part of the liquid crystal on silicon.

2. The wavelength selective switch according to claim 1,
wherein the optical compensation layer is a λ/2 plate.

3. The wavelength selective switch according to claim 1,
wherein the optical compensation layer is a liquid crystal diffraction element.
